(19) United States
(12) Patent Application Publication
(10) Pub. No.: US 2018/0083661 A1
(43) Pub. Date: Mar. 22, 2018

(54) Wideband Residual Sideband Calibration

(71) Applicant: QUALCOMM Incorporated, San Diego, CA (US)

(72) Inventors: Mohammad Emadi, San Jose, CA (US); Mazhareddin Taghivand, Campbell, CA (US); Alireza Khalili, Sunnyvale, CA (US)

(21) Appl. No.: 15/273,461

(22) Filed: Sep. 22, 2016

(51) Int. Cl. H04B 1/10

(52) U.S. Cl. CPC H04B 1/1036; H04B 1/16

(57) ABSTRACT

Various aspects of this disclosure describe the calibration of residual sideband energy in a receiver, for example estimating gain mismatch and phase mismatch in in-phase (I) and quadrature-phase channels (Q) of a receiver. An input to the receiver is supplied with an input signal generated to comprise a bandwidth including a plurality of frequencies, such as a linear frequency modulation signal. An output signal of the receiver is filtered by a filter programmed to be matched to the input signal, and estimates of gain error and phase error in I and Q channels of the receiver are determined from the filtered outputs.

### BACKGROUND

### Field of the Disclosure

The present disclosure relates to the calibration of residual sideband energy in a receiver.

### Description of Related Art

Gain and phase mismatch between in-phase (I) and quadrature-phase (Q) channels increases the residual sideband (RSB) of a transceiver radio, which degrades performance metrics, such as packet error rate. Such gain and phase mismatches can arise from multiple sources in the communications signal processing chain, including variations in component impedance across the signal bandwidth, local oscillator mismatches in I and Q terms used for quadrature demodulation, and frequency spectrum dependency in amplitude and phase of amplifiers and other circuit components.

A receiver is often calibrated by applying a tone to the receiver's front end to enable measuring gain and phase errors between I and Q channels, which can be compensated for once the errors are measured. However, the RSB is frequency dependent, so that more than one tone may be required for calibration. When the bandwidth is large, or baseband filter order is high, significantly more than one tone is needed to calibrate I and Q mismatch over the entire bandwidth. Increasing the number of tones makes the calibration costly due to the increase in test time, such as in the case of factory calibration. For example, factory calibration with a large number of tones can consume days of test time. Furthermore, circuit complexity needed to generate multiple tones can be costly, especially when the tone generation circuitry is implemented with the receiver, such as on a System-on-Chip (SoC).

### SUMMARY

This Summary is provided to introduce a selection of concepts in a simplified form that are further described below in the Detailed Description. This Summary is not intended to identify key features or essential features of the claimed subject matter.

In some aspects, a method of estimating in-phase (I) and quadrature-phase (Q) gain mismatch and phase mismatch comprises filtering an output signal of a receiver with a filter configured to be matched to an input signal to the receiver that caused the output signal to be produced. A gain mismatch and a phase mismatch of I and Q channels of the receiver are determined from the filtered output signal.

In other aspects, a computer-readable storage memory comprises an application stored as instructions that are executable for estimating in-phase (I) and quadrature-phase (Q) gain mismatch and phase mismatch. Responsive to execution of the instructions by a processor, the processor performs operations of the application comprising receiving an output signal of a receiver generated by applying an input signal comprising a bandwidth including a plurality of frequencies to an input of the receiver. Configuration parameters to configure a filter to be matched to the input signal are also received. The received output signal is filtered with the filter configured according to the configuration parameters to produce a filtered output signal. A gain mismatch and a phase mismatch of I and Q channels of the receiver are determined from the filtered output signal.

In still other aspects, a method of estimating in-phase (I) and quadrature-phase (Q) gain mismatch and phase mismatch comprises generating an input signal comprising a bandwidth including a plurality of frequencies. An input of a receiver is driven with the input signal. An output signal of the receiver is generated from driving the input of the receiver with the input signal. The output signal of the receiver is filtered with a filter matched to the input signal to produce a filtered output signal. A gain mismatch and a phase mismatch of I and Q channels of the receiver are determined from the filtered output signal.

In yet other aspects, a system for estimating in-phase (I) and quadrature-phase (Q) gain mismatch and phase mismatch comprises an input signal generator configured to generate an input signal comprising a bandwidth including a plurality of frequencies. The system also comprises a receiver configured to receive the input signal and generate an output signal. The system also comprises a calibration processor that includes a filter configured to be matched to the input signal and filter the output signal to produce a filtered output signal, and a mismatch estimator configured to determine a gain mismatch and a phase mismatch of I and Q channels of the receiver from the filtered output signal.

The foregoing is a summary and thus contains, by necessity, simplifications, generalizations and omissions of detail; consequently, those skilled in the art will appreciate that the summary is illustrative only and does not purport to be limiting in any way. Other aspects, inventive features, and advantages of the devices and/or processes described herein, as defined solely by the claims, will become apparent in the non-limiting detailed description set forth herein.

### BRIEF DESCRIPTION OF DRAWINGS

The detailed description references the accompanying figures. In the figures, the left-most digit(s) of a reference number identifies the figure in which the reference number first appears. The use of the same reference numbers in different instances in the description and the figures may indicate similar or identical items.

FIG. 1 illustrates an example receiver with gain and phase mismatch in in-phase and quadrature-phase channels in accordance with one or more aspects.

FIG. 2 illustrates an example calibration system in accordance with one or more aspects.

FIG. 3 illustrates an example input test signal for estimating gain and phase mismatch in in-phase and quadrature-phase channels in accordance with one or more aspects.

FIG. 4 illustrates an example calibration processor in accordance with one or more aspects.

FIGS. 5-7 illustrate example methods for estimating gain and phase mismatch in in-phase and quadrature-phase channels in accordance with one or more aspects.

FIG. 8 illustrates a device having components through which aspects of a residual sideband calibrator can be implemented in accordance with one or more aspects.

### DETAILED DESCRIPTION

Transceiver radios often require calibration to reduce residual sideband energy that arises from gain mismatch and phase mismatch between in-phase (I) and quadrature-phase (Q) channels of the transceiver. Aspects described herein may include a calibration system and methods to estimate gain mismatch and phase mismatch in I and Q channels of a transceiver radio. An input test signal having a bandwidth comprising a plurality of frequencies is generated and applied to an input of a receiver. An example of an input test signal is a linear frequency modulation signal. An output of the receiver, such as an output of analog signal processing comprising receiver front-end circuitry, is provided to a calibration processor. The calibration processor includes a filter that is matched to the input test signal, and filters the output of the receiver to produce filtered outputs. For example, when the input test signal is a linear frequency modulation signal, the filter comprising the calibration processor is programmed with coefficients representing, or derived from, the linear frequency modulation signal. Estimates of gain mismatch and phase mismatch in I and Q channels of the receiver are determined from the filtered outputs.

In the following discussion, an example system including an input signal generator, a receiver, and a calibration processor, techniques that elements of the example system may implement, and a device on which elements of the example system may be embodied, are described. Consequently, performance of the example procedures is not limited to the example system and the example system is not limited to performance of the example procedures. Any reference made with respect to the example system, or elements thereof, is by way of example only and is not intended to limit any of the aspects described herein.

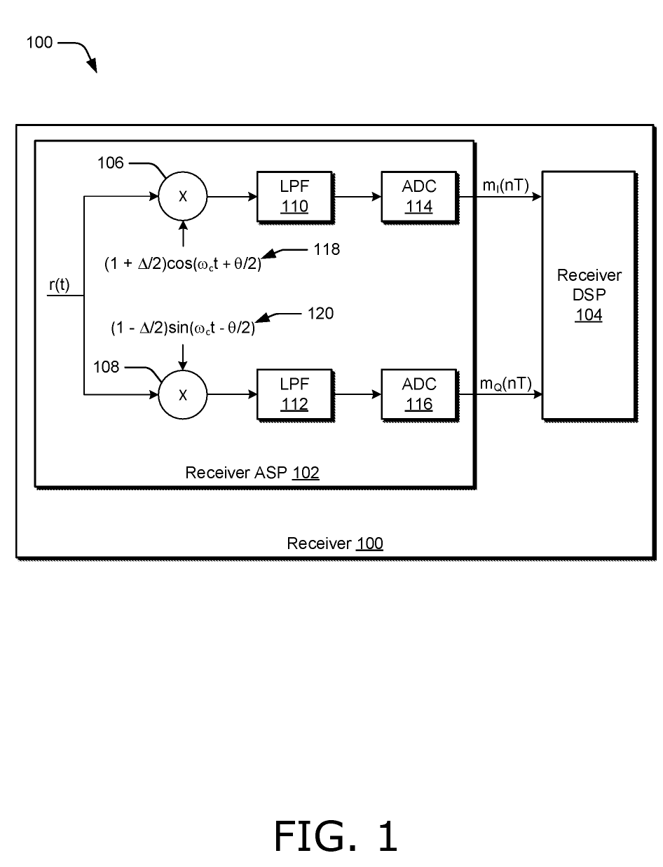

FIG. 1 illustrates an example receiver 100 in accordance with one or more aspects of the disclosure. Receiver 100 may comprise any suitable type of computing device, such as a cellular phone, tablet, laptop computer, set-top box, satellite receiver, cable television receiver, access point, desktop computer, gaming device, vehicle navigation system, cell tower, base station, cable head-end, and the like. Receiver 100 includes receiver analog signal processing (ASP) 102 and receiver digital signal processing (DSP) 104. An input signal r(t) is applied to receiver ASP 102. Input signal r(t) may be coupled to receiver ASP 102 by any suitable fashion, such as from a radio frequency wave through an antenna (not shown), from a cable connected to receiver 100 (not shown), and the like. Receiver ASP also includes exemplary modules mixers 106 and 108, low pass filters 110 and 112, and analog to digital converters 114 and 116 in respective I and Q channels. For simplicity's sake, the discussion of receiver 100 is reserved to these modules. However, various embodiments can include additional components, hardware, software and/or firmware without departing from the scope of the subject matter described herein. For example, such components not shown in FIG. 1 may include, but are not limited to, amplifiers, filters, oscillators, synthesizers, phase-locked loops, automatic gain control, antennas, tuners, demodulators, and the like.

Low pass filters 110 and 112 filter images created by mixers 106 and 108, respectively, and analog to digital converters 114 and 116 sample the outputs of low pass filters 110 and 112, respectively, to create sampled complex-valued signal m(nT)=m_{I}(nT)+j·m_{Q}(nT), where j=\sqrt{−1}, T is the sampling period, an n is a sequence of integers. The sampled complex-valued signal is provided to receiver DSP 104, which performs suitable signal processing digitally, such as, by way of example and not limitation, frequency translation, timing recovery, transforms such as a Fast Fourier Transform, equalization, error decoding and correction, and the like. Furthermore, in some embodiments, sampled complex-valued signal m(nT)=m_{I}(nT)+j·m_{Q}(nT) is an output signal of receiver 100 that is used to estimate gain mismatch and phase mismatch in I and Q channels of receiver 100.

I and Q channels of receiver 100 are formed by providing real-valued input signal r(t) to mixers 106 and 108 that are also provided quadrature local oscillator signals 118 and 120 for frequency translation, such as down-conversion. That is, mixer 106 multiplies input signal r(t) with the I component of quadrature local oscillator signal 118, and mixer 108 multiplies input signal r(t) with the Q component of quadrature local oscillator signal 120, thus splitting the receiver into I and Q channels, respectively. Though mixers 106 and 108 are shown as a single stage of down-conversion in FIG. 1, some embodiments use multiple stages of frequency translation, such as translating from a radio frequency (RF) to an intermediate frequency (IF), and then translating the IF to a baseband (BB), or near-BB, signal.

Quadrature local oscillator signals 118 and 120 are respectively modeled by

$$( 1 + \frac{Δ}{2} ) cos ( {ω}_{c} t + \frac{θ}{2} ) and ( 1 - \frac{Δ}{2} ) sin ( {ω}_{c} t - \frac{θ}{2} ) ,$$

where ω_{c} is the local oscillator signal frequency, t denotes time, and Δ and θ represent gain mismatch and phase mismatch, respectively, between I and Q channels of receiver 100. Such gain and phase mismatches can arise from multiple sources in the communications signal processing chain, including variations in component impedance across the signal bandwidth, local oscillator mismatches used to generate the quadrature local oscillator signals 118 and 120, and frequency spectrum dependency in amplitude and phase of amplifiers and other modules not shown in receiver 100 for clarity.

Gain mismatch and phase mismatch cause an increase in residual sideband energy, which degrades receiver performance metrics, such as packet error rate (PER). For example, energy of the residual sideband caused by gain mismatch and phase mismatch can be modeled by

$$RSB = \frac{\frac{{Δ}^{2}}{4} {sin}^{2} \frac{θ}{2} + {cos}^{2} \frac{θ}{2}}{\frac{{Δ}^{2}}{4} {cos}^{2} \frac{θ}{2} + {sin}^{2} \frac{θ}{2}} .$$

When Δ and θ are zero, residual sideband energy is minimized. However, non-zero gain mismatch and phase mismatch result in residual sideband energy that can allow leakage of energy from one side of the data spectrum to the other side of the data spectrum, degrading performance.

Having considered a discussion of an example receiver with gain and phase mismatch in in-phase and quadrature-phase channels that cause residual sideband energy, consider now a discussion of an example residual sideband calibration system.

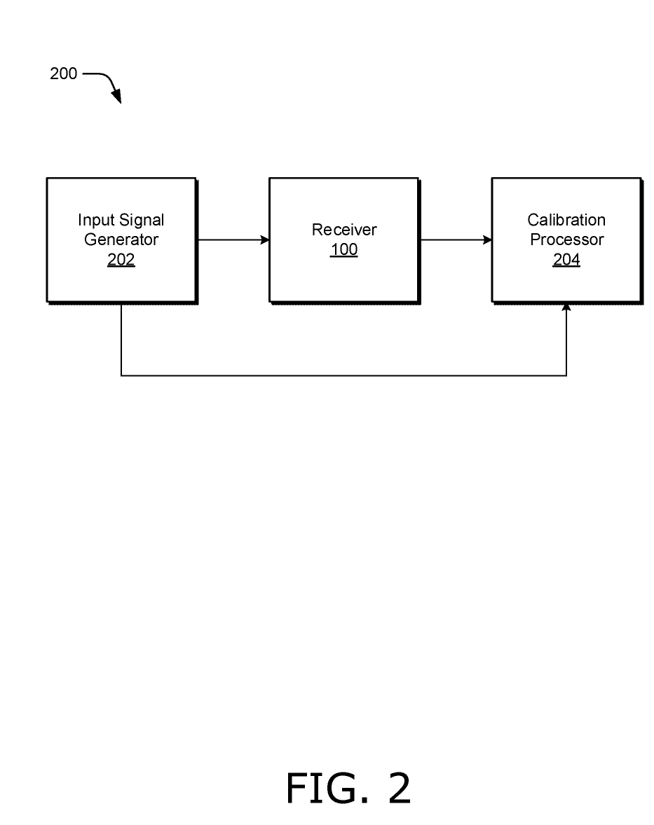

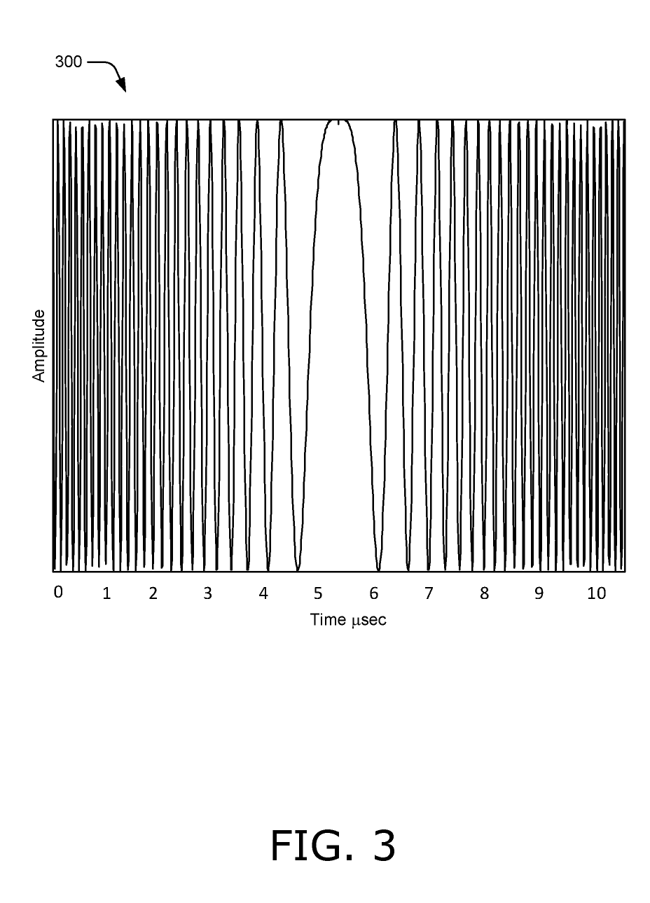

FIG. 2 illustrates an example calibration system 200 in accordance with one or more embodiments. Calibration system 200 comprises receiver 100 connected via a receiver input to input signal generator 202 and connected via a receiver output to calibration processor 204. Input signal generator 202 generates an input signal that is applied to an input of receiver 100, such as signal r(t) in FIG. 1. The input signal generated by input signal generator 202 has a bandwidth comprising a plurality of frequencies. In embodiments, the input signal generated by input signal generator 202 comprises a chirp, such as a linear frequency modulation signal. A linear frequency modulation signal has its instantaneous frequency varying linearly over time, or f(t)=f₀+ρ·t where f(t) is the instantaneous frequency at time t, f₀ is an initial frequency, and ρ is a stepsize indicating rate of frequency change, which can be signed so as to cause a chirp with increasing frequency, decreasing frequency, or a combination thereof. For example, FIG. 3 illustrates an example input test signal 300 in accordance with one or more embodiments. Input test signal 300 illustrated in FIG. 3 is a linear frequency modulation signal with decreasing frequency for the first time period corresponding to about 0-5.25 μsec, and with increasing frequency for the second time period corresponding to about 5.25-10.5 μsec.

Referring again to FIG. 2, input signal generator 202 is configurable to generate a variety of input signals. Input signal generator 202 can generate an input signal comprising a plurality of signals each with a bandwidth comprising a plurality of frequencies. For example, input signal generator 202 is configurable to generate a plurality of linear frequency modulation signals each with a different center frequency. By using a plurality of linear frequency modulation signals each with a different center frequency instead of the tones at the center frequencies themselves, the number of center frequencies needed to be tested is reduced compared to just using the tones at the center frequencies. Therefore, calibration test time is reduced.

In other embodiments, input signal generator 202 is configured to generate an input signal comprising a sequence generated from a Barker code. A Barker code is a finite-length sequence of +1's and −1's which minimizes non-cyclic autocorrelation values. Input signals generated by input signal generator 202 using other codes are also contemplated. For example, golden codes, code division multiple access (CDMA) spreading codes, scrambling codes, spread spectrum codes, and the like, can be used to configure input signal generator 202 to generate an input signal having a bandwidth comprising a plurality of frequencies that can be used in system 200 to estimate gain mismatch and phase mismatch in I and Q channels of receiver 100 and calibrate residual sideband energy.

The input signal generated by input signal generator 202 is supplied to an input of receiver 100, causing receiver 100 to generate a receiver output signal that is supplied as input to calibration processor 204. In embodiments, sampled complex-valued signal m(nT)=m_{I}(nT)+j·m_{Q}(nT) shown in FIG. 1 is an output signal of receiver 100 that is provided to calibration processor 204. Any suitable output signal from receiver 100 may be supplied to calibration processor 204. For example, output signals from receiver DSP 104 may have undergone digital signal processing, such as digital down-conversion, and be supplied as input to calibration processor 204.

Calibration processor 204 receives an output signal from receiver 100 as input, as well as a configuration signal from input signal generator 202. The configuration signal from input signal generator 202 contains information regarding the input signal created by input signal generator 202 that is supplied to receiver 100. The configuration signal can be used by calibration processor 204 to estimate the gain mismatch and phase mismatch in I and Q channels of receiver 100. For example, the configuration signal from input signal generator 202 may contain parameters that enable a filter comprising calibration processor 204 to be matched to the input signal generated by input signal generator 202 that is supplied to receiver 100. The parameters contained in the configuration signal from input signal generator 202 may comprise coefficients that can be programmed into a filter comprising calibration processor 204 so that the filter is matched to the input signal generated by input signal generator 202. Alternatively or additionally, parameters in the configuration signal may comprise terms that can be used to generate filter coefficients. Parameters in the configuration signal may also include settings for selecting a type of filter, such as transversal, infinite impulse response (IIR), lattice, frequency domain, and the like. Calibration processor 204 uses an output signal of receiver 100 and the configuration signal from input signal generator 202 to estimate the gain mismatch and phase mismatch in I and Q channels of receiver 100, as will be described in more detail below.

Components of system 200 may operate to calibrate residual sideband energy of receiver 100 by estimating gain mismatch and phase mismatch in I and Q channels of receiver 100 as part of a factory calibration. Input signal generator 202 may comprise standard test equipment, such as a laboratory signal or waveform generator. Calibration processor 204 may comprise special test equipment, such as programmable logic configured for calibration of residual sideband energy of a receiver.

Components of system 200 may operate to calibrate residual sideband energy of receiver 100 by estimating gain mismatch and phase mismatch in I and Q channels of receiver 100 upon start-up of receiver 100, such as responsive to a wake-up signal, responsive to receiver 100 being powered on, or responsive to a calibration control signal indicating that calibration is scheduled, due, or requested by a user (e.g., at a time other than device startup). Input signal generator 202, receiver 100, and calibration processor 204 may comprise a same device. For example, input signal generator 202, receiver 100, and calibration processor 204 may comprise a user device such as a cellular phone, tablet, laptop computer, set-top box, satellite receiver, cable television receiver, access point, desktop computer, gaming device, vehicle navigation system, and the like. Furthermore, input signal generator 202, receiver 100, and calibration processor 204 may comprise a System-on-Chip (SoC).

Input signal generator 202 may comprise a service provider and provide an input signal and configuration signal to a separate device comprising receiver 100. The input signal and configuration signal may be communicated to the separate device comprising receiver 100 over a network, such as the Internet, intranet, local area network, personal area network, body network, or combination of networks. Upon receiving the input signal and configuration signal, receiver 100 may be configured to process the input signal and provide an output signal to calibration processor 204.

Calibration processor 204 comprises the device that comprises receiver 100. Calibration processor 204 may comprise the service provider, and receiver 100 may be configured to communicate an output signal to the service provider comprising calibration processor 204 over a network or networks, such as a same network used to communicate the input signal and configuration signal to receiver 100. Alternatively, a different network other than the network used to communicate the input signal and configuration signal to receiver 100 is used to communicate an output signal to the service provider comprising calibration processor 204.

Having considered a discussion of an example residual sideband calibration system and an example input test signal for estimating gain and phase mismatch in I and Q receiver channels, consider now a discussion of an example calibration processor.

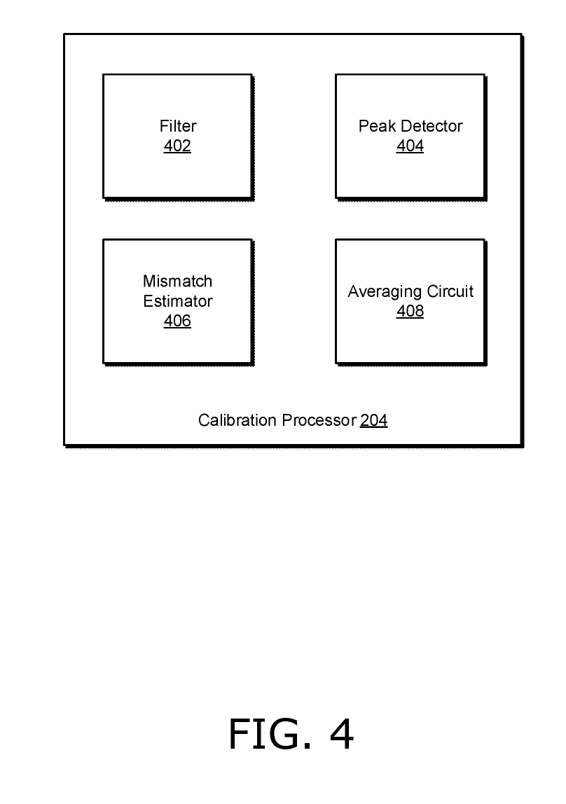

FIG. 4 illustrates an example calibration processor 204 in accordance with one or more embodiments. Calibration processor 204 comprises filter 402, peak detector 404, mismatch estimator 406, and averaging circuit 408. Filter 402 is configurable to filter an output signal of receiver 100 with coefficients matched to the input signal generated by input signal generator 202. Peak detector 404 is configurable to detect a peak at the output of filter 402. Mismatch estimator 406 estimates gain mismatch and phase mismatch in I and Q channels of receiver 100 from the peak detected in peak detector 404 and outputs of filter 402. Averaging circuit 408 averages estimates of gain mismatch and phase mismatch determined in mismatch estimator 406.

Filter 402 may be a programmable filter that is configured to be matched to the input signal generated by input signal generator 202. For example, filter 402 may be programmed with coefficients corresponding to an output of receiver ASP 102 when the input signal from input signal generator 202 is applied to the input of receiver 100 and gain mismatch and phase mismatch are zeroed, i.e., Δ=0 and θ=0. In such cases, complex-valued filter coefficients f(t)=f_{I}(t)+j·f_{Q}(t) for filter 402 may be set from sampled values of f_{I}(t)=r(t)·cos(ω_{c}t) and f_{Q}(t)=r(t)·sin(ω_{c}t) where r(t) is the input signal from input signal generator 202 applied to the input of receiver 100. By programming filter 402 with coefficients corresponding to an output of receiver ASP 102 when driven by the input signal from input signal generator 202 and when gain mismatch and phase mismatch are zeroed, filter 402 is matched to the input signal by matching the filter coefficients to a receiver output without mismatch when driven by the input signal.

Complex-valued filter coefficients f(t)=f_{I}(t)+j·f_{Q}(t) for filter 402 may be set from sampled values of f_{I}(t)=φ₁[r(t)] and f_{Q}(t)=φ₂[r(t)] where φ₁ and φ₂ are suitable operators, including, by way of example and not limitation, trigonometric functions, conjugation, scaling, rotation, frequency transform, resampling, interpolation, combinations thereof, and the like. Complex-valued filter coefficients f(t) may be filtered before being programmed into filter 402. For example, complex-valued filter coefficients f(t) can be filtered by LPF's 110 and 112 and/or other components in receiver 100 processing chain and the result used to set coefficients that are programmed into filter 402.

Estimates of gain mismatch and phase mismatch are determined by filtering an output of receiver 100 when driven by the input signal from input signal generator 202, with filter 402 programmed with coefficients that are matched to the input signal. Let \hat{x}=\hat{x}₁+j·\hat{x}_{Q} be the complex-valued output of filter 402 and m=m_{I}+j·m_{Q} be the output signal measured from receiver 100 and used as input to filter 402, where time dependencies are dropped for clarity. The complex-valued output of filter 402, \hat{x}=\hat{x}₁+j·\hat{x}_{Q}, is therefore the convolution of m=m_{I}+j·m_{Q} with f=f_{I}−j·f_{Q} where f represents the coefficients of filter 402 with appropriate complex conjugation. The outputs of filter 402 may be separated and written as

$${\hat{x}}_{I} = \int [ {f}_{I} {f}_{Q} ] \cdot [ \begin{matrix}{m}_{I} \\ {m}_{Q}\end{matrix} ] = \int [ {f}_{I} {f}_{Q} ] \cdot [ \begin{matrix}( 1 + \frac{Δ}{2} ) cos θ & - ( 1 + \frac{Δ}{2} ) sin θ \\ ( 1 - \frac{Δ}{2} ) sin θ & ( 1 - \frac{Δ}{2} ) cos θ\end{matrix} ] \cdot [ \begin{matrix}{f}_{I} \\ {f}_{Q}\end{matrix} ] = ( 1 + \frac{Δ}{2} \cdot F ) \cdot cos θ$$

$$and$$

$${\hat{x}}_{Q} = \int [ - {f}_{Q} {f}_{I} ] \cdot [ \begin{matrix}{m}_{I} \\ {m}_{Q}\end{matrix} ] = \int [ - {f}_{Q} {f}_{I} ] \cdot [ \begin{matrix}( 1 + \frac{Δ}{2} ) cos θ & - ( 1 + \frac{Δ}{2} ) sin θ \\ ( 1 - \frac{Δ}{2} ) sin θ & ( 1 - \frac{Δ}{2} ) cos θ\end{matrix} ] \cdot [ \begin{matrix}{f}_{I} \\ {f}_{Q}\end{matrix} ] = ( 1 - \frac{Δ}{2} \cdot F ) \cdot sin θ$$

where

$$F = {\int }_{0}^{T} cos ( 2 \cdot BW \cdot \frac{{t}^{2}}{T} )$$

dt is a constant for a given input signal bandwidth BW, and symbol period T.

These equations representing the outputs of filter 402 are two simultaneous equations in the two unknowns Δ and θ. Therefore, Δ and θ can be estimated by simultaneous solution to these equations using known techniques. The values of the output of filter 402, \hat{x}=\hat{x}_{I}+j·\hat{x}_{Q}, can be set in these equations from the filter output corresponding to a peak found in peak detector 404. By ensuring that input signal generator 202 generates an input signal with sufficient bandwidth, filter 402 when programmed with coefficients matched to the input signal will produce an output with a peak that can be detected by peak detector 404.

Mismatch estimator 406 solves the two simultaneous equations above using an output of filter 402, such as the output of filter 402 corresponding to a peak found in peak detector 404, for a prescribed input signal bandwidth, BW, and symbol period, T. The input signal bandwidth, BW, can be set sufficiently large to affect a desired phase resolution for a specified symbol period, T. Estimates of gain mismatch and estimates of phase mismatch from mismatch estimator 406 that result from simultaneous solution of the above equations are provided to averaging circuit 408 for averaging, such as time-ensemble averaging and/or averaging across frequencies.

Filter 402, peak detector 404, and mismatch estimator 406 can process a plurality of signals corresponding to input signals generated by input signal generator 202 each with different center frequencies. Thus, filter 402, peak detector 404, and mismatch estimator 406 operate to produce a plurality of estimates of gain mismatch and phase mismatch, such as corresponding to the different center frequencies, which can be averaged in averaging circuit 408. Averaging circuit 408 is configured to average a plurality of estimates of gain mismatch and average a plurality of estimates of phase mismatch over different frequencies. In embodiments, averaging circuit 408 averages a plurality of estimates of gain mismatch and separately averages a plurality of estimates of phase mismatch, the estimates corresponding to an input signal generated by input signal generator 202 comprising a plurality of linear frequency modulation signals each with a different center frequency.

Having considered a discussion of an example calibration processor for estimating gain and phase mismatch in in-phase and quadrature-phase channels that cause residual sideband energy, consider now a discussion of example methods for estimating gain and phase mismatch in in-phase and quadrature-phase channels.

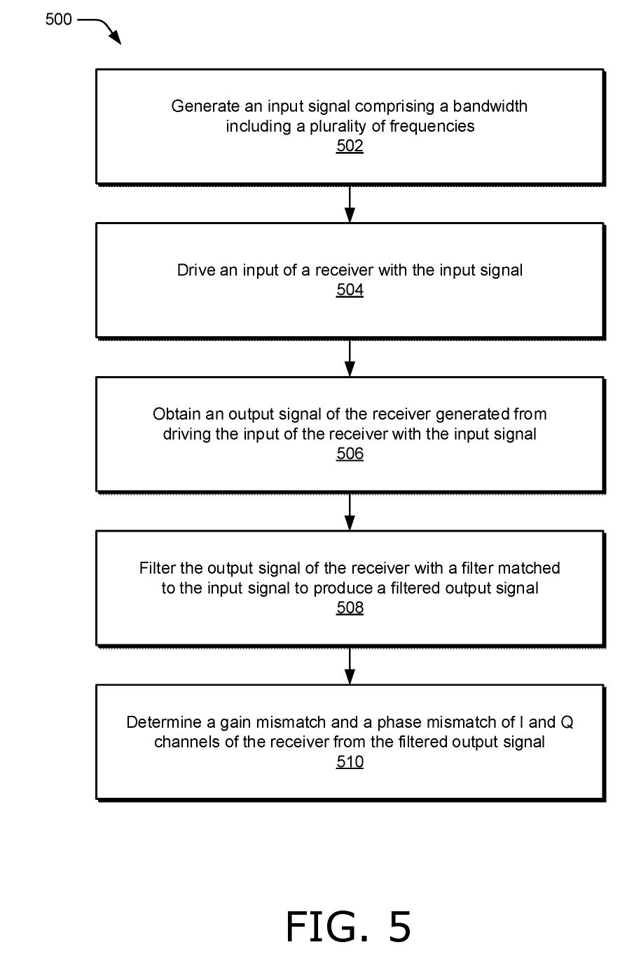

FIG. 5 illustrates an example procedure 500 for estimating gain and phase mismatch in in-phase and quadrature-phase channels in accordance with one or more embodiments. Aspects of the procedure may be implemented in hardware, firmware, software, or a combination thereof. The procedure is shown as a set of blocks that specify operations performed by one or more devices and are not necessarily limited to the orders shown for performing the operations by the respective blocks. In at least some embodiments the procedure may be performed by a suitably configured device or devices, such as a device or devices comprising the example receiver 100, example input signal generator 202, and example calibration processor 204 described in system 200 of FIG. 2.

An input signal comprising a bandwidth including a plurality of frequencies is generated (block 502). For example, the input signal can be one or more linear frequency modulation signals, and the linear frequency modulation signals can be applied to different center frequencies. Thus, the bandwidths of the one or more linear frequency modulation signals can be aggregated to form the bandwidth including the plurality of frequencies. The bandwidth including the plurality of frequencies can comprise a continuum of frequencies, rather than a number of discrete tones. A continuum of frequencies can be generated with a linear frequency modulation signal with prescribed start and stop frequencies, for example. A number of continuums of frequencies may be aggregated to form a bandwidth of the input signal comprising a continuum of frequencies. Input signal generator 202 in FIG. 2 is an example module that can generate the input signal at block 502 in FIG. 5.

An input of a receiver is driven with the input signal (block 504). The input of the receiver is driven by applying the input signal to the input of the receiver causing the receiver to process the input signal and produce an output signal. An example receiver is illustrated at receiver 100 in FIG. 1. The input signal can be applied to the input by any suitable fashion, including through electronic cabling connected to the receiver, RF transmissions through an antenna, optical transfer over a fiber optic cable or wirelessly, and the like. The input signal may be real valued. Alternatively, the input signal may be complex valued and both I and Q components of the complex-valued input signal may be applied as input to the receiver via one or more receiver inputs.

An output signal of the receiver generated from driving the input of the receiver with the input signal is obtained (block 506). The output signal can be any suitable output of the receiver obtained by any available output port. In embodiments, the output signal of the receiver is a digitized output signal of analog signal processing circuitry comprising front-end receiver signal processing. For example, sampled complex-valued signal m(nT)=m_{I}(nT)+j·m_{Q}(nT) in FIG. 1 is an example output signal of a receiver that is obtained at block 506 in FIG. 5. An example port used to obtain the output signal of the receiver includes a test port, a pin or trace capable of being probed, such as with a logic analyzer, a connector capable of accepting a reciprocal or mating connector, or a bridge, and the like.

The output signal of the receiver is filtered with a filter matched to the input signal to produce a filtered output signal (block 508). The filter can be matched to the input signal by setting the filter coefficients based on the input signal in any suitable fashion. In embodiments, the filter coefficients are determined from a quadrature demodulation of the input signal by mixing the input signal with quadrature local oscillator terms and using the result to set the filter coefficients. The input signal can be filtered by a low-pass filter or low-pass filters and the filter coefficients may be determined from the filtered input signal. The filter coefficients are programmable, and determining the filter coefficients to match the input signal can be based on a configuration signal that contains parameters about the input signal, such as the frequency range, rate of change, duration, and center frequency of a linear frequency modulation input signal. Furthermore, the filter structure can be any suitable filter structure, such as a linear, transversal filter, an infinite impulse response filter, a lattice filter, a frequency-domain filter, combinations thereof, and the like. An example filter that can filter the output signal obtained at block 508 in FIG. 5 is filter 402 in FIG. 4.

A gain mismatch and a phase mismatch of I and Q channels of the receiver are determined from the filtered output signal (block 510). Estimates of gain mismatch and phase mismatch are determined by solving a system of equations derived from the filtered output signal for a given bandwidth of the input signal and symbol period. A peak of the output signal can be detected and used to construct the system of equations. A plurality of estimates of gain mismatch and a plurality of estimates of phase mismatch may be determined, and each plurality averaged across different frequencies. For example, estimates can be generated from a plurality of input signals comprising a plurality of linear frequency modulated signals with different center frequencies. Calibration processor 204 in FIG. 4 is an example module that can determine gain mismatch and phase mismatch of I and Q channels of the receiver at block 510 in FIG. 5.

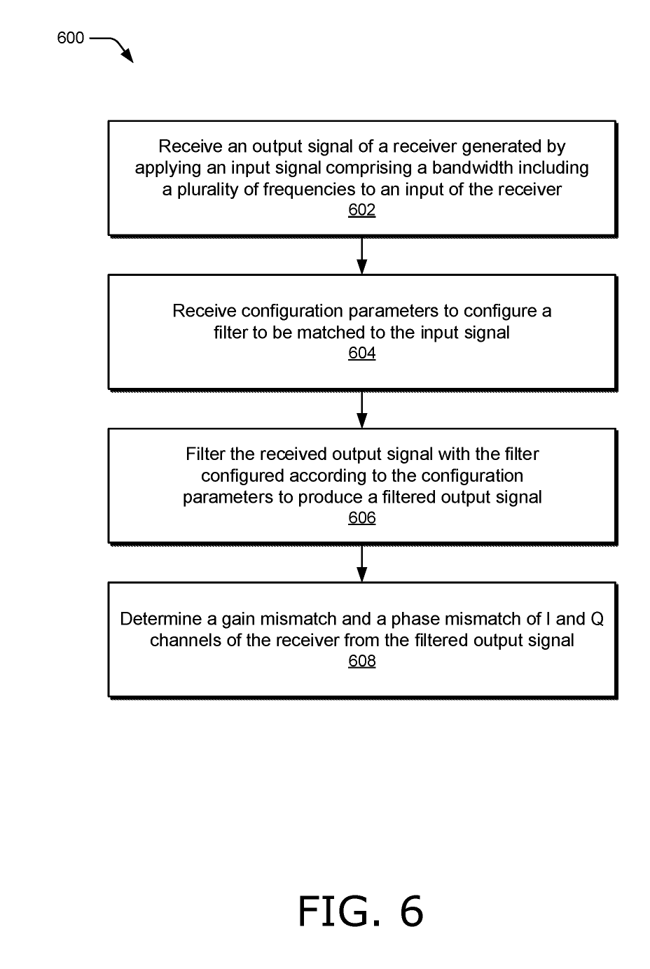

FIG. 6 illustrates an example procedure 600 for estimating gain and phase mismatch in in-phase and quadrature-phase channels in accordance with one or more embodiments. Aspects of the procedure may be implemented in hardware, firmware, software, or a combination thereof. The procedure is shown as a set of blocks that specify operations performed by one or more devices and are not necessarily limited to the orders shown for performing the operations by the respective blocks. In at least some embodiments the procedure may be performed by a suitably configured device or devices, such as a device or devices comprising the example calibration processor 204 described in FIG. 4.

An output signal of a receiver generated by applying an input signal comprising a bandwidth including a plurality of frequencies to an input of the receiver is received (block 602). The output signal can be received by any suitable fashion, such as in a file transferred over a network, as a live signal as part of a calibration test, communicated over a bus or interconnect from a module that is part of the device that receives the output signal, and the like. Consider three non-limiting examples. In a first example, the output of the receiver may be obtained at a service provider that performs a calibration of a user device, and the user device may obtain an input signal from the service provider and return a corresponding receiver output signal to the service provider for determination of calibration parameters for the user device. In a second example, the output signal may be received at a user device that performs a self-calibration by applying the input signal to a receiver comprising the user device and receiving a corresponding output signal of the receiver at a module of the user device that determines calibration parameters based on gain mismatch and phase mismatch between I and Q channels of the receiver. In a third example, a factory calibration of a user device can be performed by receiving the receiver output signal while the user device is under test and calibration parameters based on gain mismatch and phase mismatch between I and Q channels of the receiver are determined.

Configuration parameters to configure a filter to be matched to the input signal are received (block 604). Configuration parameters can be received as part of a configuration signal that contains information regarding the input signal applied to the receiver. For example, the parameters contained in the configuration signal may comprise coefficients that can be programmed into the filter. The configuration signal can contain parameters about the input signal, such as the frequency range, rate of change, duration, and center frequency of a linear frequency modulation input signal. Configuration parameters can also include local oscillator parameters that can be used to perform a quadrature split of the input signal in order to determine coefficients for the filter, such as initial oscillator state or phase, control word, and/or phase or frequency stepsize. Using the received configuration parameters, the filter is programmed to be matched to the input signal according to any suitable fashion.

The received output signal is filtered with the filter configured according to the configuration parameters to produce a filtered output signal (block 606). The filter can comprise any suitable filter structure, such as a linear, transversal filter, an infinite impulse response filter, a lattice filter, a frequency-domain filter, combinations thereof, and the like.

A gain mismatch and a phase mismatch of I and Q channels of the receiver are determined from the filtered output signal (block 608). Estimates of gain mismatch and phase mismatch are determined by solving a system of equations derived from the filtered output signal for a given bandwidth of the input signal and symbol period. A peak of the output signal may be detected and used to construct the system of equations. A plurality of estimates of gain mismatch and a plurality of estimates of phase mismatch can be determined, and each plurality averaged across different frequencies. For example, estimates can be generated from a plurality of input signals comprising a plurality of linear frequency modulated signals with different center frequencies.

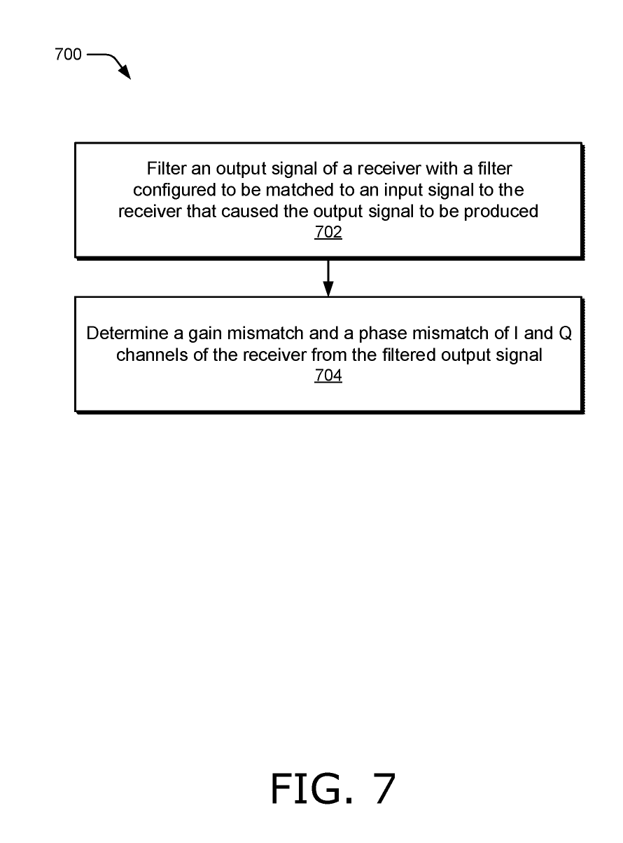

FIG. 7 illustrates an example procedure 700 for estimating gain and phase mismatch in in-phase and quadrature-phase channels in accordance with one or more embodiments. Aspects of the procedure may be implemented in hardware, firmware, software, or a combination thereof. The procedure is shown as a set of blocks that specify operations performed by one or more devices and are not necessarily limited to the orders shown for performing the operations by the respective blocks. In at least some embodiments the procedure may be performed by a suitably configured device or devices, such as a device or devices comprising the example calibration processor 204 described in FIG. 4.

An output signal of a receiver is filtered with a filter configured to be matched to an input signal to the receiver that caused the output signal to be produced (block 702). That is, the receiver processes an input signal causing the output signal to be produced, and the output signal is filtered with a filter whose coefficients are set to match the input signal by deriving the filter coefficients from the input signal in any suitable fashion. An example filter is filter 402 in FIG. 4; an example input signal is an input signal generated by input signal generator 202 in FIG. 2; and an example output signal is sampled complex-valued signal m(nT)=m_{I}(nT)+j·m_{Q}(nT) shown in FIG. 1.

A gain mismatch and a phase mismatch of I and Q channels of the receiver are determined from the filtered output signal (block 704). Estimates of gain mismatch and phase mismatch are determined by solving a system of equations derived from the filtered output signal for a given bandwidth of the input signal and symbol period. A peak of the output signal may be detected and used to construct the system of equations. A plurality of estimates of gain mismatch and a plurality of estimates of phase mismatch can be determined, and each plurality averaged across different frequencies. For example, estimates can be generated from a plurality of input signals comprising a plurality of linear frequency modulated signals with different center frequencies.

Having considered a discussion of example methods for estimating gain and phase mismatch in in-phase and quadrature-phase channels, consider now a discussion of an example device having components through which aspects of a residual sideband calibrator can be implemented.

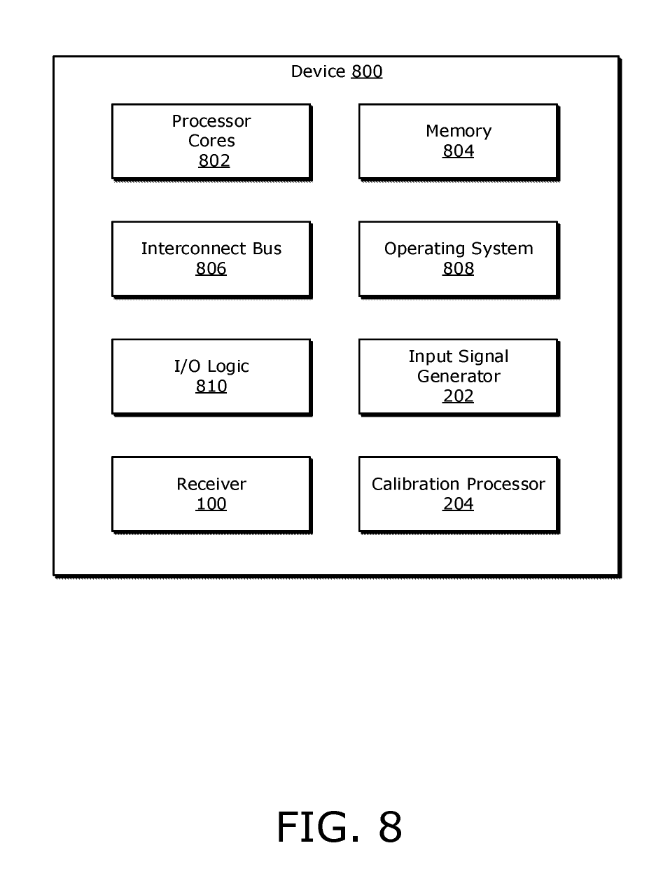

FIG. 8 illustrates an example device 800, which includes components capable of implementing aspects of calibrating residual sideband energy by estimating gain error and phase error in I and Q channels of a receiver. Device 800 may be implemented as, or in, any suitable electronic device, such as a modem, broadband router, access point, cellular phone, smart-phone, gaming device, laptop computer, net book, set-top-box, smart-phone, network-attached storage (NAS) device, cell tower, satellite, cable head-end, and/or any other device that may receive data.

Device 800 may be integrated with a microprocessor, storage media, I/O logic, data interfaces, logic gates, a transmitter, a receiver, circuitry, firmware, software, and/or combinations thereof to provide communicative or processing functionalities. Device 800 may include a data bus (e.g., cross bar or interconnect fabric) enabling communication between the various components of the device. In some aspects, components of device 800 may interact via the data bus to implement aspects of calibrating residual sideband energy by estimating gain error and phase error in I and Q channels of a receiver.

In this particular example, device 800 includes processor cores 802 and memory 804. Memory 804 may include any suitable type of memory, such as volatile memory (e.g., DRAM), non-volatile memory (e.g., flash), cache, and the like. In the context of this disclosure, memory 804 is implemented as a storage medium, and does not include transitory propagating signals or carrier waves. Memory 804 can store data and processor-executable instructions of device 800, such as operating system 808 and other applications. Processor cores 802 may execute operating system 808 and other applications from memory 804 to implement functions of device 800, the data of which may be stored to memory 804 for future access. For example, processor cores may implement receiver and calibration functions. Device 800 may also include I/O logic 810, which can be configured to provide a variety of I/O ports or data interfaces for communication.

Device 800 also includes input signal generator 202 as illustrated in FIG. 2. Input signal generator 202 generates an input signal comprising a bandwidth including a plurality of frequencies that can be used to calibrate residual sideband energy by estimating gain error and phase error in I and Q channels of a receiver, such as receiver 100 also included in device 800.

Device 800 also includes calibration processor 204 as illustrated in FIG. 4. Calibration processor 204 determines estimates of gain error and phase error in I and Q channels of a receiver using the input from input signal generator 202 and output of receiver 100.

In one or more exemplary embodiments, the functions described may be implemented in hardware, software, firmware, or any combination thereof. If implemented in software, functions may be stored on a computer-readable storage medium (CRM). In the context of this disclosure, a computer-readable storage medium may be any available medium that can be accessed by a general-purpose or special-purpose computer that does not include transitory propagating signals or carrier waves. By way of example, and not limitation, such media can comprise RAM, ROM, EEPROM, CD-ROM or other optical disk storage, magnetic disk storage, or other magnetic storage devices, or any other non-transitory medium that can be used to carry or store information that can be accessed by a general-purpose or special-purpose computer, or a general-purpose or special-purpose processor. The information can include any suitable type of data, such as computer-readable instructions, sampled signal values, data structures, program components, or other data. These examples, and any combination of storage media and/or memory devices, are intended to fit within the scope of non-transitory computer-readable media. Disk and disc, as used herein, includes compact disc (CD), laser disc, optical disc, digital versatile disc (DVD), floppy disk and Blu-ray disc where disks usually reproduce data magnetically, while discs reproduce data optically with a laser. Combinations of the above should also be included within the scope of computer-readable media.

Firmware components include electronic components with programmable memory configured to store executable instructions that direct the electronic component how to operate. In some cases, the executable instructions stored on the electronic component are permanent, while in other cases, the executable instructions can be updated and/or altered. At times, firmware components can be used in combination with hardware components and/or software components.

The term “component”, “module”, and “system” are indented to refer to one or more computer related entities, such as hardware, firmware, software, or any combination thereof, as further described above. At times, a component may refer to a process and/or thread of execution that is defined by processor-executable instructions. Alternately or additionally, a component may refer to various electronic and/or hardware entities.

Certain specific embodiments are described above for instructional purposes. The teachings of this disclosure have general applicability, however, and are not limited to the specific embodiments described above. The residual sideband calibration is not limited to use in receivers that communicate in accordance with any particular interface standard such as LTE, UMB, or WiMAX, but rather the residual sideband calibration has general applicability to other interface standards. Furthermore, the teachings of this disclosure have been described for a receiver portion of a transceiver radio. One skilled in the art would readily understand how to apply the teachings of this disclosure to a transmitter portion of a transceiver radio to estimate gain and phase mismatch in in-phase and quadrature-phase channels of the transmitter portion in accordance with one or more aspects.

1. A method comprising:
generating, with an input signal generator of a device, a calibration test signal comprising a bandwidth including a plurality of frequencies;
driving an input of a receiver of the device with the calibration test signal generated by the device;
obtaining an output signal of the receiver generated from the driving the input of the receiver with the calibration test signal generated by the device;
filtering the output signal of the receiver with a filter matched to the calibration test signal to produce a filtered output signal; and
calibrating the receiver based on the filtered output signal.

2. The method as recited in claim 1, wherein the calibrating comprises determining a gain mismatch and a phase mismatch of I and Q channels of the receiver.

3. The method as recited in claim 2, wherein the determining a gain mismatch and a phase mismatch comprises determining a phase and an amplitude from a peak of the filtered output signal.

4. The method as recited in claim 1, wherein the calibration test signal comprises a linear frequency modulation signal.

5. The method as recited in claim 4, further comprising programming the filter with coefficients representing the linear frequency modulation signal.

6. The method as recited in claim 1, wherein the calibration test signal comprises a plurality of linear frequency modulation signals each with a different center frequency.

7. The method as recited in claim 1, further comprising performing the generating, the driving, the obtaining, the filtering, and the calibrating upon start-up of the receiver.

8. The method as recited in claim 1, further comprising setting the bandwidth according to a desired phase resolution.

9. A system comprising:
an input signal generator configured to generate a test signal comprising a bandwidth including a plurality of frequencies, the test signal generated by increasing a frequency of the test signal over a first duration of the test signal and decreasing the frequency over a second duration of the test signal;
a receiver configured to receive the test signal and generate an output signal; and
a calibration processor comprising:
a filter configured to be matched to the test signal and filter the output signal to produce a filtered output signal; and
a mismatch estimator configured to determine a gain mismatch or a phase mismatch of I and Q channels of the receiver from the filtered output signal.

10. The system as recited in claim 9, wherein the test signal comprises a linear frequency modulation signal.

11. The system as recited in claim 10, wherein the filter is programmed with coefficients representing the linear frequency modulation signal.

12. The system as recited in claim 9, wherein the test signal comprises a plurality of linear frequency modulation signals each with a different center frequency.

13. The system as recited in claim 9, wherein the input signal generator, the receiver, and the calibration processor comprise separate respective devices.

14. The system as recited in claim 9, wherein the input signal generator and the calibration processor comprise part of the receiver.

15. A method comprising:
filtering an output signal of a receiver with a filter configured to be matched to an input signal to the receiver that caused the output signal to be produced; and
determining a gain mismatch or a phase mismatch of I and Q channels of the receiver by solving a system of simultaneous equations constructed from the filtered output signal.

16. The method as recited in claim 15, wherein the input signal comprises a linear frequency modulation signal.

17. The method as recited in claim 16, wherein the filter is configured to be matched to the input signal by programming the filter with coefficients representing the linear frequency modulation signal.

18. The method as recited in claim 15, further comprising performing the filtering and the determining responsive to the receiver being powered on.

19. The method as recited in claim 15, wherein the input signal is real valued and the output signal and the filtered output signal are complex valued.

20. The method as recited in claim 15, wherein the input signal comprises a sequence generated from a Barker code.

21. A device comprising:
means for receiving an output signal of a receiver generated by applying an input signal comprising a bandwidth including a plurality of frequencies to an input of the receiver, the input signal including a first portion over which a frequency of the input signal is increased and a second portion over which the frequency is decreased;
means for receiving configuration parameters to configure a filter to be matched to the input signal;
means for filtering the received output signal with the filter configured according to the configuration parameters to produce a filtered output signal; and
means for calibrating the receiver based on the filtered output signal.

22. The device as recited in claim 21, wherein the means for calibrating comprise means for determining a gain mismatch and a phase mismatch of I and Q channels of the receiver.

23. The device as recited in claim 21, wherein the input signal comprises a linear frequency modulation signal.

24. The device as recited in claim 23, wherein to configure the filter to be matched to the input signal comprises to program the filter with coefficients representing the linear frequency modulation signal.

25. The device as recited in claim 22, wherein the configuration parameters comprise filter coefficients for the filter.
